(19) United States
(12) Patent Application Publication
(10) Pub. No.: US 2025/0262995 A1
(43) Pub. Date: Aug. 21, 2025

(54) CAR SEAT WITH ADJUSTABLE SIDE IMPACT PROTECTION AND ADJUSTABLE SELF-DEPLOYING INNER ARM RESTS

(71) Applicant: Britax Child Safety, Inc., Fort Mill, SC (US)

(72) Inventors: Quentin Walsh, Fort Mill, SC (US); Trent Cook, Fort Mill, SC (US); Joseph Bryant, Fort Mill, SC (US); Angela Stacey, St. John’s Newfoundland (CA)

(73) Assignee: Britax Child Safety, Inc., Fort Mill, SC (US)

(21) Appl. No.: 19/052,917

(22) Filed: Feb. 13, 2025

Related U.S. Application Data
(60) Provisional application No. 63/685,468, filed on Aug. 21, 2024.
(60) Provisional application No. 63/555,482, filed on Feb. 20, 2024.

(51) Int. Cl. B60N 2/28

(52) U.S. Cl. CPC B60N 2/2884; B60N 2/2851

(57) ABSTRACT

A child safety seat includes an outer shell, an adjustable headrest, and an impact protection module. The adjustable headrest is moveable with respect to the outer shell between a first position and a second position. The impact protection module is coupled to the adjustable headrest such that the IPM moves in coordination with the adjustable headrest.

### PRIORITY CLAIM AND CROSS-REFERENCE TO RELATED APPLICATIONS

The present application claims priority to and the benefit of U.S. Provisional Patent Application No. 63/685,468 filed Aug. 21, 2024, and U.S. Provisional Patent Application No. 63/555,482 filed Feb. 20, 2024, which are incorporated herein by reference in their entirety and relied upon.

### TECHNICAL FIELD

The present invention is generally related to child restraint systems, and more specifically to seats (e.g., child safety seats) specially adapted for vehicles. More particularly, the present invention relates to a car seat, such as a juvenile car seat, with adjustable side impact protection and adjustable self-deploying inner arm rests. The juvenile car seat or child safety seat is designed to offer improved protection in various crash configurations, in particular in crash configurations involving a side impact.

### BACKGROUND

Car seats (e.g., child safety seats) are designed to protect children in vehicles from the effects of impacts or sudden changes in motion (e.g., sudden acceleration, sudden deceleration, or the like). Many conventional child safety seats are designed to provide optimized protection in frontal crash configurations. However, approximately 25% of all crashes occur from the side. Injuries received in side impact crashes are generally more severe than those typically received in front crashes. It is estimated that up to 30% of all fatalities are a result of side impact crashes. Moreover, car seats with adjustable headrests allow for use with different-height infants and larger occupants. Current car seats do not include inner armrests that adjust in conjunction with headrest adjustment. As a result, current car seats can be uncomfortable for infant occupants, that cannot reach the main armrests of the car seat. As a result, there is a great need for effective and reliable side impact protection in child safety seats and armrests that deploy and self-adjust according to headrest adjustments.

### SUMMARY

Systems and methods for a child safety seat with adjustable side impact protection and adjustable self-deploying inner arm rests in accordance with embodiments of the invention are disclosed. An example child safety seat includes an outer shell, an adjustable headrest, and an impact protection module. The adjustable headrest is moveable with respect to the outer shell between a first position and a second position. The impact protection module is coupled to the adjustable headrest such that the IPM moves in coordination with the adjustable headrest.

In light of the disclosure herein, and without limiting the scope of the invention in any way, in a first aspect of the present disclosure, which may be combined with any other aspect listed herein unless specified otherwise, a child safety seat including an outer shell; an adjustable headrest, the headrest moveable with respect to the outer shell between a first position and a second position; and at least one impact protection module (“IPM”), where the IPM is coupled to the adjustable headrest such that the IPM moves in coordination with the adjustable headrest.

In a second aspect of the present disclosure, which may be combined with any other aspect listed herein unless specified otherwise, the at least one IPM is sized and shaped to cover a protection area of interest on a child occupying the child safety seat.

In a third aspect of the present disclosure, which may be combined with any other aspect listed herein unless specified otherwise, the at least one IPM is laterally adjustable to a plurality of different lateral positions and where the at least one IPM is vertically adjustable to a plurality of different vertical positions.

In a fourth aspect of the present disclosure, which may be combined with any other aspect listed herein unless specified otherwise, the IPM has compression characteristics based on a lateral position of the first IPM.

In a fifth aspect of the present disclosure, which may be combined with any other aspect listed herein unless specified otherwise, further comprising a linking member attached to the IPM and the adjustable headrest.

In a sixth aspect of the present disclosure, which may be combined with any other aspect listed herein unless specified otherwise, further comprising a moveable vent cover, where the linking member includes a plurality of vents and the moveable vent cover is configured to selectively change a state of at least one of the plurality of vents.

In a seventh aspect of the present disclosure, which may be combined with any other aspect listed herein unless specified otherwise, the state of at least one of the plurality of vents includes an open state, a closed state, and a partially open state.

In an eighth aspect of the present disclosure, which may be combined with any other aspect listed herein unless specified otherwise, at least one of the IPM and the linking member include at least one vent.

In a ninth aspect of the present disclosure, which may be combined with any other aspect listed herein unless specified otherwise, the at least one vent includes a plurality of closable vents configured to change compression characteristics of the IPM based on which of the plurality of vents is open or closed.

In a tenth aspect of the present disclosure, which may be combined with any other aspect listed herein unless specified otherwise, the at least one IPM includes a first IPM arranged on an upper portion of a first side of the child safety seat.

In an eleventh aspect of the present disclosure, which may be combined with any other aspect listed herein unless specified otherwise, further comprising a second IPM arranged on a lower portion of the first side of the child safety seat, wherein the second IPM is threadingly attached to the child safety seat, and wherein further thread engagement between the IPM and the child safety seat causes the IPM to laterally move towards a centerline of the child safety seat.

In a twelfth aspect of the present disclosure, which may be combined with any other aspect listed herein unless specified otherwise, the at least one adjustable IPM includes a first IPM on a left-hand-side of the child safety seat and a second IPM is arranged on a right-hand-side of the child safety seat.

In a thirteenth aspect of the present disclosure, which may be combined with any other aspect listed herein unless specified otherwise, an impact protection module (“IPM”) adapted for a child safety seat, including a compressible body portion having an inward facing surface and an outward facing surface, the inward facing surface configured to contact an outer shell of the child safety seat upon impact, thereby transferring impact forces to the outer shell of the child safety seat; and a coupling interface configured for removably and adjustably coupling the IPM to the child safety seat.

In a fourteenth aspect of the present disclosure, which may be combined with any other aspect listed herein unless specified otherwise, the coupling interface is configured to couple the IPM to an adjustable headrest of the child safety seat such that movement of the adjustable headrest and the IPM are linked with each other.

In a fifteenth aspect of the present disclosure, which may be combined with any other aspect listed herein unless specified otherwise, the IPM is one of (i) a hollow rigid body, (ii) an inflatable body, (iii) a semi-rigid body, (iv) a burstable body, or a combination thereof.

In a sixteenth aspect of the present disclosure, which may be combined with any other aspect listed herein unless specified otherwise, the compressible body portion includes a plurality of sub-members, and the plurality of sub-members includes a first sub-member, a second sub-member, and a third sub-member, and at least one of the sub-members includes a vent.

In a seventeenth aspect of the present disclosure, which may be combined with any other aspect listed herein unless specified otherwise, at least one sub-member of the plurality of sub-members has a different compression characteristic than at least one other sub-member of the plurality of sub-members.

In an eighteenth aspect of the present disclosure, which may be combined with any other aspect listed herein unless specified otherwise, a child safety seat including an inner shell, with a back area and a seat area; inner arm rests, the inner arm rests moveable with respect to the back of the inner shell between a first position and a second position; and an adjustable headrest, the adjustable headrest moveable in a top vertical position and a bottom vertical position with respect to a seating area of the child safety seat.

In a nineteenth aspect of the present disclosure, which may be combined with any other aspect listed herein unless specified otherwise, the inner shell includes inner arm cavities corresponding in size with the inner arm rests, and the inner arm rests move between the first position and the second position such that the arm rests are in the first position when the adjustable headrest is in the top vertical position, and the arm rests are in the second position when the adjustable headrest is in the bottom vertical position.

In a twentieth aspect of the present disclosure, which may be combined with any other aspect listed herein unless specified otherwise, in the first position the inner arm rests are stored in the inner arm cavities, and in the second position the inner arm rests are in a position parallel with the seat area of the inner shell.

In a twenty-first aspect of the present disclosure, any of the structure, functionality, and alternatives disclosed in connection with any one or more of FIGS. 1A to 11 may be combined with any other structure, functionality, and alternatives disclosed in connection with any other one or more of FIGS. 1A to 11.

Other objects, advantages and novel features, and further scope of applicability of the present invention will be set forth in part in the detailed description to follow, and in part will become apparent to those skilled in the art upon examination of the following, or may be learned by practice of the invention. The objects and advantages of the invention may be realized and attained by means of the instrumentalities and combinations particularly pointed out in the claims.

### BRIEF DESCRIPTION OF THE DRAWINGS

The description will be more fully understood with reference to the following figures, which are presented as exemplary embodiments of the invention and should not be construed as a complete recitation of the scope of the invention, wherein:

FIG. 1A is a perspective view of a child safety seat in accordance with an embodiment of the invention;

FIG. 1B is a side view of a child safety seat in accordance with an embodiment of the invention;

FIG. 2 is a side view of a child safety seat in accordance with an embodiment of the invention;

FIG. 3A is a perspective view of a child safety seat in accordance with an embodiment of the invention;

FIGS. 3B and 3C are partial enlarged views of the translation channels of the child safety seat of FIG. 3A in accordance with an embodiment of the invention;

FIG. 4A is a perspective view of an impact protection module coupled to an adjustable headrest in accordance with an embodiment of the invention;

FIGS. 4B, 4C and 4D are block diagram schematic views of an impact protection module and vented linking member in accordance with one or more example embodiments of the invention;

FIG. 5A is a perspective view of a child safety seat with the adjustable headrest and impact protection modules in an operating position in accordance with an embodiment of the invention;

FIG. 5B is a perspective view of the child safety of FIG. 5A with the adjustable headrest and impact protection modules in a different operating position in accordance with an embodiment of the invention;

FIG. 6A is a block diagram schematic view of a child safety seat with impact protection modules in a first lateral position in accordance with an embodiment of the invention;

FIG. 6B is a block diagram schematic of the child safety seat of FIG. 6A with the impact protection modules in a second lateral position in accordance with an embodiment of the invention;

FIG. 7A is a partial side view of an impact protection mechanism coupled to a child safety seat in accordance with an embodiment of the invention;

FIG. 7B is a partial side view of an impact protection mechanism coupled to a child safety seat in accordance with an embodiment of the invention;

FIG. 8 is a front view of a child safety seat in accordance with an embodiment of the invention;

FIG. 9 is a side view of a child safety seat with adjustable self-deploying inner arm rests in a deployed configuration in accordance with an embodiment of the invention;

FIG. 10 is a side view of a child safety seat with adjustable self-deploying inner arm rests in a stored configuration in accordance with an embodiment of the invention.

FIG. 11 is a side view of a child safety seat with adjustable self-deploying inner arm rests between a deployed and stored configuration in accordance with an embodiment of the invention.

### DETAILED DESCRIPTION

Turning now to the drawings, systems, and methods for a child safety seat with adjustable side impact protection in accordance with embodiments of the inventions are disclosed. It should be appreciated that although the term “child safety seat” or “car seat” is used herein, the “car seat” or “child safety seat” may be a convertible car seat and may alternatively be referred to as a safety seat (e.g., child safety seat), a restraint system (e.g., child restraint system), or the like. Additionally, it should be appreciated that although the term “child” is used herein to describe the occupant of the car seat, the “child” may alternatively be referred to generally as occupant or as an infant, juvenile, or the like. Furthermore, it should be appreciated that although the term “car” is used herein, the “car” may alternatively be referred to generally as a vehicle (e.g., motorized vehicle, passenger vehicle, and other similar vehicles). Additionally, it should be appreciated that the car can be interchangeably used with truck, van, sports utility vehicle (“SUV”), or the like. Generally, there are two modes of car seats, rear-facing and forward facing. Rear-facing car seats can be used for newborn and toddlers. Forward-facing car seats can be used for children that fit the height and weight requirements associated with the forward-facing car seats. While it is important for a car seat to be properly secured to a vehicle (e.g., car seat or underlying structure) to protect the child, it is also important that the car seat be properly sized and configured to support the child correctly and provide maximum protection in the event of an impact.

Car seats typically include a hard plastic shell, occupant restraint harness and adjusting strap, securing latches, padding and a dress cover. Side torso protection is provided by the combination of the hard shell and the overlying padding. Head protection often includes separate outwardly-projecting side wings on the upper headrest part of the shell that limit the extent of sideways head movement and cushion the limited sideways head movement that does occur.

Head and torso side impact protection is provided by the hard plastic of the shell and the overlying protective padding elements. However, impacts sufficient to fully compress or “bottom out” the outer padding layers can cause severe lateral movement of the entire seat with the potential of wrenching the seat from its anchoring elements and increasing the severity of injury to the seat occupant. Simply adding more and more side padding is often not a satisfactory solution, in that it increases the weight, mass and volume of the seat. Increasing the weight and mass of the seat results in greater latent energy stored in the seat, and thus the potential for greater damage in the event of a severe side impact.

Car seats in accordance with embodiments of the invention include side impact protection modules that are selectively adjustable and removable, which advantageously allows the modules to provide protection to the child's head and neck area regardless of the stage of the child's growth (e.g., the impact protection modules translate along with headrest to maintain alignment with target protection areas on the child). Additionally, lateral adjustability advantageously allows the impact modules to provide protection in different seating arrangements and vehicle configurations (e.g., lateral adjustment may be used to account for distance between the car seat and other occupants or vehicle interior features, such as a protruding arm rest). Furthermore, removability of the impact protection modules allows modules to be removed from one or more portions of the car seat (e.g., removing impact protection modules from a right hand side of the car seat when another passenger is sitting adjacent the right hand side, or removing impact protection modules from a side of the car seat that is furthest from a vehicle door interior). By removing impact protection modules that would otherwise provide minimal additional protection to the child occupant, the weight, mass and volume of the seat is advantageously reduced. Reducing the weight and mass of the car seat results in less latent energy stored in the seat, and thus the potential for less damage in the event of a severe side impact.

### Child Safety Seat

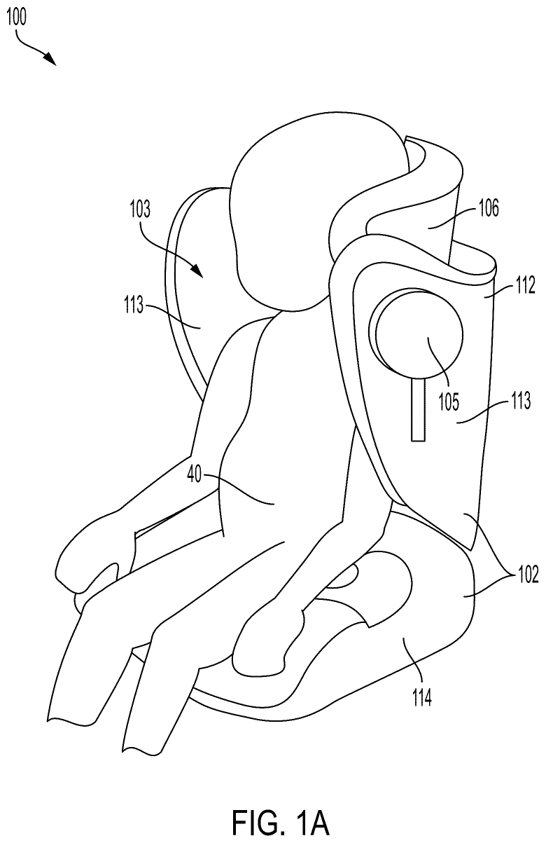

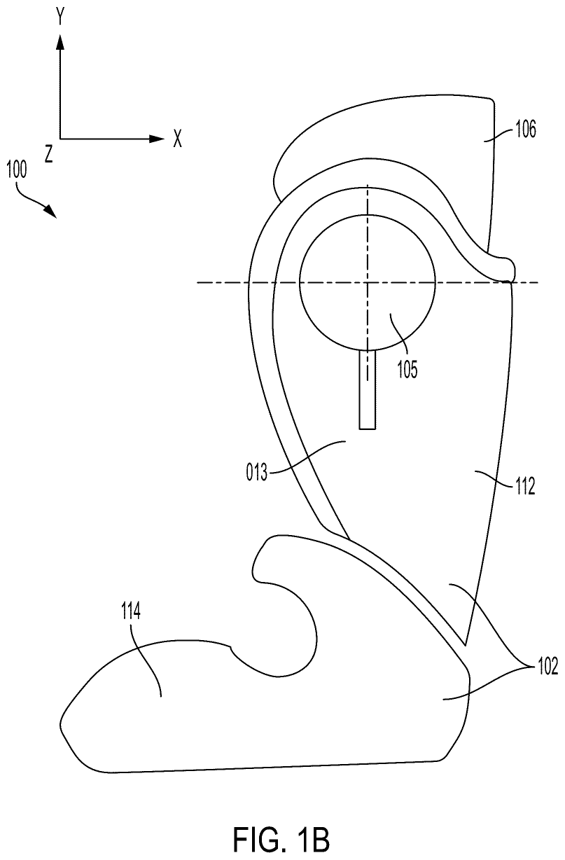

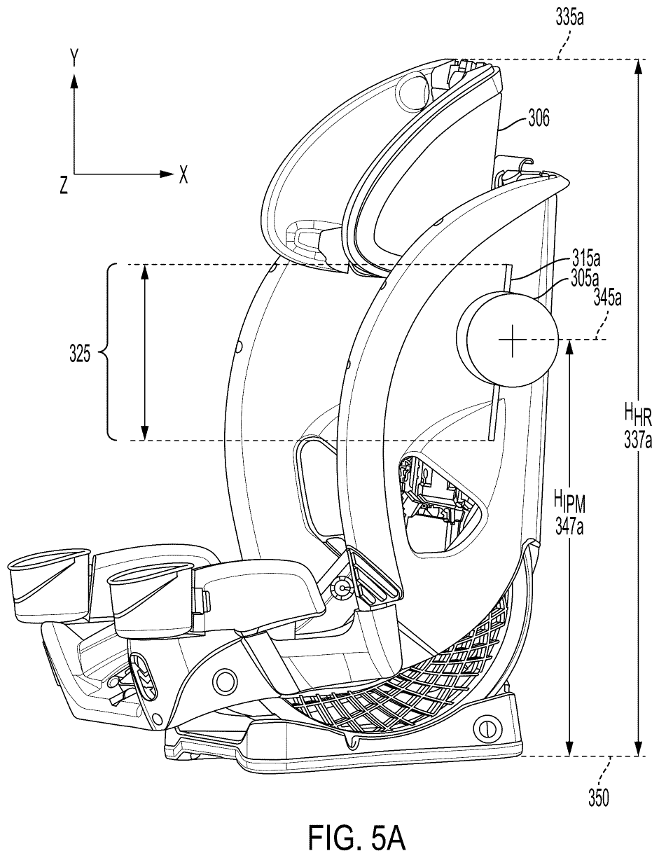

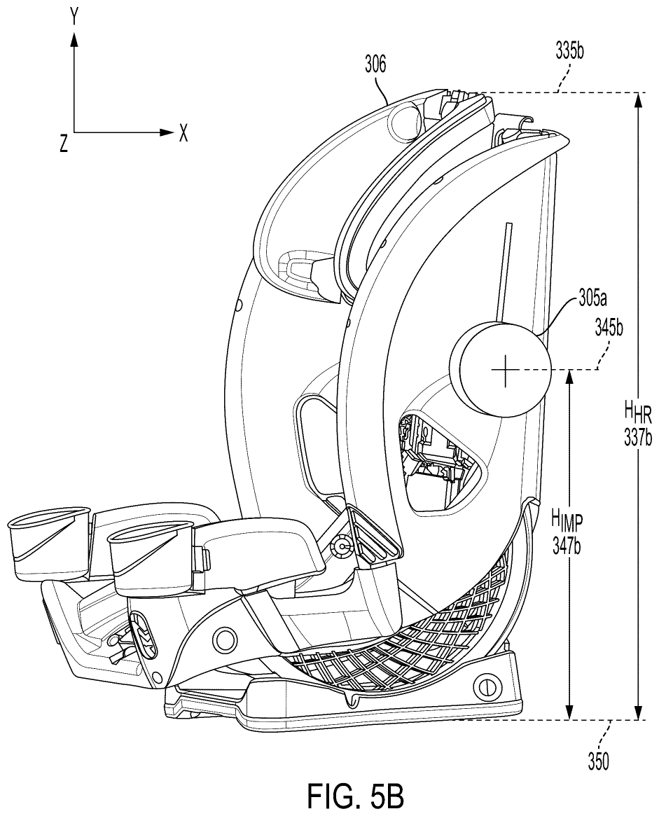

FIG. 1A shows a child safety seat 100 for transporting an occupant (e.g., child 40) in a vehicle in accordance with an example embodiment of the present disclosure. The child safety seat 100 may comprise an outer shell 102, which encloses a seating area 103 for a child 40. The outer shell 102 may comprise a backrest 112 having side wings 113. The outer shell 102 may furthermore comprises a base portion 114. In addition, the child safety seat 100 may comprise a headrest 106 coupled (e.g., mounted) to the backrest 112. The headrest 106 is adjustable in a generally vertical direction with respect to the base portion 114. The adjustability of headrest 106 is described in more detail below (see FIGS. 5A and 5B and corresponding description). When the child safety seat 100 is in use, a child 40 sits on the base portion 114 with their back supported by the backrest 112 (e.g., child leans against the backrest 112) with the child's head supported by headrest 106 (e.g., back of child's head positioned on and leaning against the headrest 106). The child safety seat 100 may comprise a soft goods cover (not shown) for the child's comfort. The soft goods cover is configured to be located between the child 40 and at least the base portion 114, the backrest 112, and the headrest 106. Notably, the soft goods cover can be a single piece of multiple separate pieces. In one embodiment, the soft goods cover is comprised of a soft material such as, but not limited to, an EPP foam, where the soft material is covered by a fabric. As illustrated in FIG. 1A, the headrest 106 may be sized and shaped to limit the extent of sideways head movement and cushion the limited sideways head movement that may occur. The side wings 113 are configured to enclose the child's 40 torso on both sides. The child safety seat 100 furthermore comprises adjustable impact protection modules (“IPMs”) 105 positioned about the outer shell 102. In an example, the adjustable IPM(s) 105 are positioned about the side wings 113 of the outer shell 102.

The impact protection modules or IPMs 105 may be sized, shaped, and configured to protect against side impacts. For example, the adjustable IPMs 105 may be adjustable side-impact protection modules, but it should be appreciated that the IPMs 105 can protect against other types of impacts, collisions, or accidents. Specifically, during a head-on collision, a rear-end collision or other vehicle accidents, the child safety seat 100 may be propelled in various directions and portions of the vehicle or objects within the vehicle may be propelled towards the car seat 100.

As illustrated in FIG. 1A, one adjustable IPM 105 is visible, but it should be appreciated that both sides of the child safety seat 100 may include adjustable IPM(s) 105. For example, another IPM 105 positioned about the right side wing 113 is hidden from view due to the right side wing 113. In an example, the adjustable IPM(s) 105 are adjustably coupled to the child safety seat (e.g., on the outer shell 102, the adjustable headrest 106, among other locations) and positioned in the vicinity of or near a child's head and shoulders. The IPM(s) 105 may also be coupled to the headrest 106. When in use, the IPM(s) 105 protrude laterally from the outer shell 102, and more specifically the side wings 113 such that the IPM(s) are configured to be a first point of contact during a side-impact.

Conventionally, when transporting a child in a vehicle, a child safety seat is mounted to one of the seats of the vehicle. Therefore, when installed in a vehicle, a child safety seat is typically positioned in close proximity to at least one of the doors of the vehicle. In case of a side crash of a vehicle carrying a child safety seat, the child safety seat may impact on one of the doors of the vehicle (e.g., intruding door). If this impact is severe, the child sitting in the child safety seat may incur injuries from the side impact collision.

The IMP(s) 105 of the child safety seat protrude laterally from the outer shell 102, such that in the case of the vehicle carrying the child safety seat 100 experiences a side impact (e.g., side impact, crash or collision), the IPM 105 (facing the door corresponding to the side impact, e.g., the “intruding door”) is the first component of the child safety seat 100 to come in contact with the impacted portion of the vehicle (e.g., portion of vehicle door, such as an armrest). Therefore, the IMP(s) 105 may be used to control the dynamics of the impact of the child safety seat 100 on the vehicle at a very early stage.

FIG. 1B shows a side view of the child safety seat of FIG. 1A. As illustrated in FIG. 1B, the IPM(s) 105 may be sized, shaped, and arranged to cover a large portion of an upper region of the outer shell 102, such as the side wing 113. Therefore, forces impacting on the IPM(s) 105 which are transferred from the IPM(s) 105 to the outer shell 102 (e.g., side wing 113) are distributed over a large area of the outer shell 102. As a result, the occurrence of high peak forces acting on an upper region of the outer shell, such as side wing(s) 113, can be avoided. This is advantageous because high peak forces may damage portions of the cars seat, and more specifically the outer shell 102 (e.g., the side wing(s) 113), thereby resulting in severe injuries of the child 40.

In an example, the child safety seat 100 may be similar in construction to a seat (e.g., convertible car seat 100) disclosed in US 2023/0256874 to the Applicant. In view of this, a number of components of the child safety seat 100 may not be described herein in detail because they are described in US 2023/0256874 in relation to convertible car seat 100. Instead, reference is made to the corresponding description and drawings of US 2023/0256874, which are incorporated herein by reference in their entirety. It should be appreciated that the IPM(s) 105 may be sized, shaped and arranged to work with a variety of headrests, and specifically with headrests capable of translating vertically along (e.g., up and down) the seatback. In an example, the IPM(s) 105 may include universal linking or mounting hardware to enable to IPM(s) 105 to be mounted to and adapted for different headrest designs.

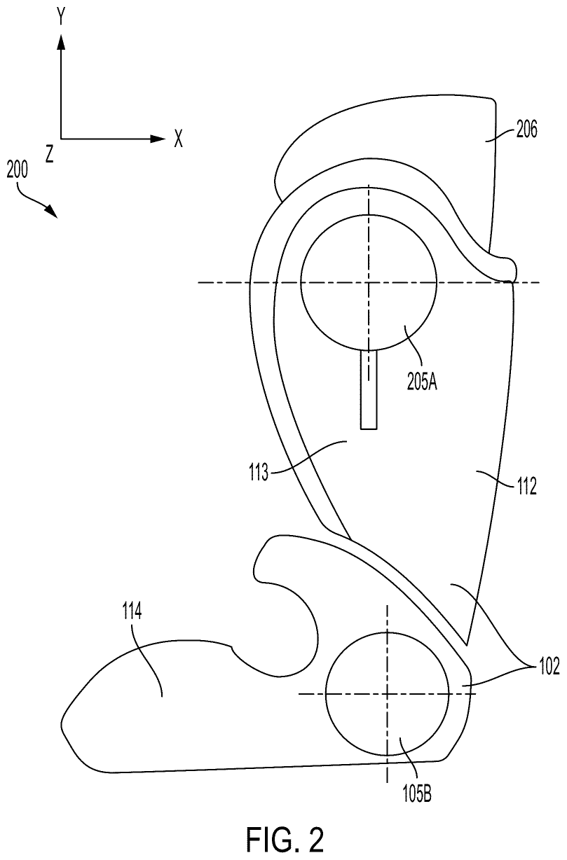

FIG. 2 shows a side view of a child safety seat 200 in accordance with another example embodiment of the invention. This child safety seat 200 illustrated in FIG. 2 comprises two IPMs on each side of the child safety seat. In particular, the child safety seat 200 comprises a first IPM 205A which is positioned about the side wing 213 and a second IPM 205B which is positioned about the base portion 214. Similar to FIG. 1A, FIG. 2 only shows the left side of the child safety seat 200, therefore only two IPMs 205A, 205B are visible. Two additional IPMs, which are not visible in FIG. 2, may be attached to the opposite side of the child safety seat 200. By providing two IPMs on each side of the child safety seat 200, the potential contact area between IPMs on the child safety seat 200 and the vehicle can be increased. By providing additional contact area with IPMs 205 (e.g., IPM 205A and IPM 205B), the IPMs may collectively absorb a greater amount of impact forces and/or absorb impact forces from additional points of collision/contact. The first IPM 205A and the second IPM 205B constitute two load paths to guide impact forces to the outer shell 2 during a side crash. By providing two load paths, the distribution of impact forces across the outer shell 2 can be improved. In the illustrated example of FIG. 2, it should be appreciated that the contact area of each IPM 205A and 205B may be determined by the size and shape of the IPM and/or other interior features of the vehicle the child safety seat occupies.

While the invention relates broadly to juvenile seating products, many of the Figures and corresponding detailed description are made with reference to a child safety seat (e.g., child safety seat 100, 200). However, the invention is not limited to the specific style of car seat illustrated in the Figures. It should be appreciated that the disclosure applies to “Rear-Facing Car Seats” and “Forward-Facing Car Seats,” including: infant car seats (rear-facing only) designed for newborns and small babies, convertible seats that change from a rear-facing seat to a forward-facing seat with a harness and tether, combination seats that transition from a forward-facing seat with a harness and tether into a booster as a child grows, all-in-one seats that change from a rear-facing seat to a forward-facing seat (with a harness and tether) and to a booster seat as a child grows. The disclosure also applies to “Booster Seats,” including: booster seats with high back that are designed to boost a child's height so a seat belt fits properly while providing neck and head support (ideal for vehicles that do not have headrests or high seat backs), backless booster seats that are designed to boost a child's height so a seat belt fits properly (ideal for vehicles that have headrests), combination seats, and all-in-one seats.

It should be appreciated that depending on (i) the placement of the child safety seat 100, 200 within the vehicle, (ii) position of other occupants or objects within the vehicle, and (iii) vehicle characteristics (e.g., shape and configuration of interior doors, armrests, fold down storage), the child safety seat 100, 200 may only utilize IPMs 105, 205 on one side of the child safety seat 100, 200.

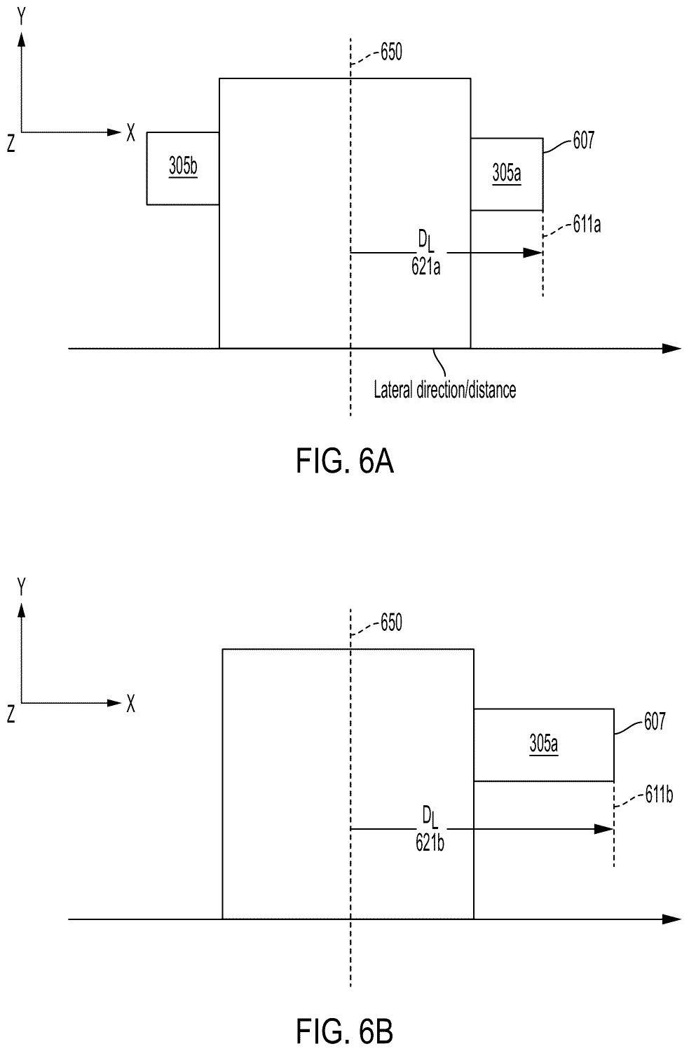

The IPMs 105 of the child safety seat 100 of FIGS. 1A and 1B and the IPMs 205A and 205B of the child safety seat 200 of FIG. 2 may be configured to be stowable or removable such that the IPMs 105, 205 can either be placed in a functioning orientation to protect the child or a storage orientation. Advantageously, the IPMs are configured to protrude further from the outer shell 102, 202 of the child safety seat when disposed in the functioning orientation, thereby providing side impact protection, than when disposed in the storage orientation. Additionally, the IPMs 105, 205A, 205B may be configured to adjust to various different positions within the functioning orientation. For example, IPM(s) 105, 205 may be selectively adjustable to various different heights (e.g., vertical position) on outer shell 102, 202 and/or various different depths (e.g., lateral position) on outer shell 102, 202. The selective adjustability is described in more detail below in relation to FIGS. 5A, 5B, 6A and 6B.

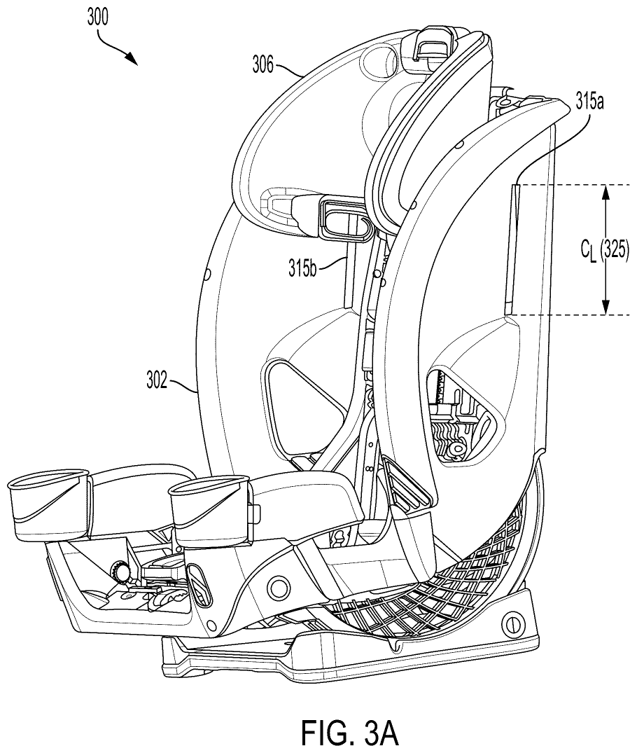

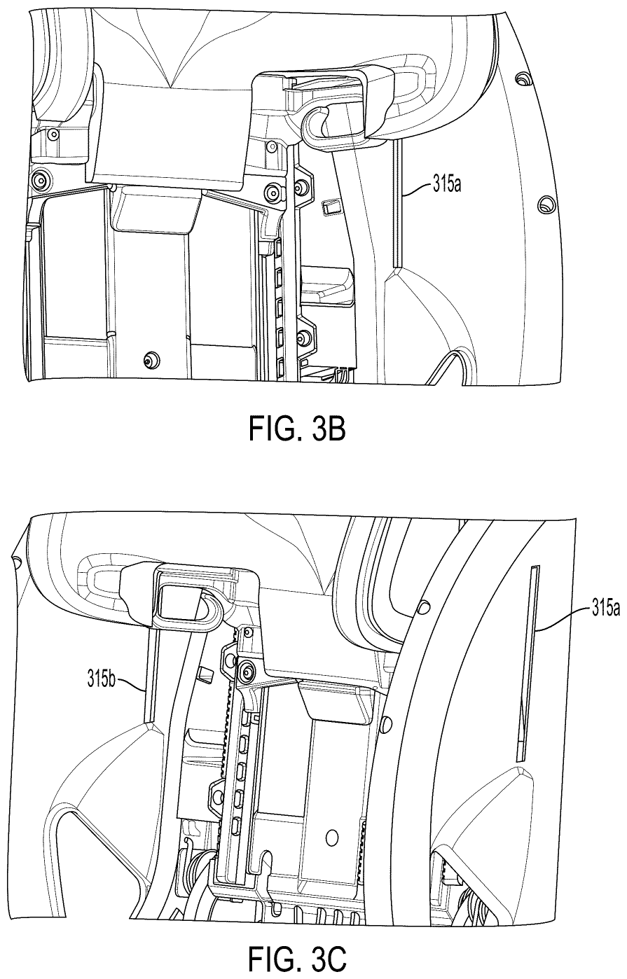

FIG. 3A illustrates another example child safety seat 300 (note that the child safety seat 300 is depicted without any padding, over-layer or covering materials to provide better visibility into the structural shell and translation channels). In the illustrated example, the child safety seat 300 has an outer shell 302 and an adjustable headrest 306. It should be appreciated that the child safety seat 300 may include the same or similar features and components to the child safety seat 1, illustrated in FIGS. 1A, 1B, and 2. The child safety seat 300 may also include one or more IPM translation channels 315a, 315b. In the illustrated example, translation channel 315a is on the left-hand-side (“LHS”) of the child safety seat 300 while translation channel 315b is on the right-hand-side (“RHS”) of the child safety seat 300 (note that sides are from the perspective of the occupant). The translation channels, generally referred to herein as translation channel(s) 315, are configured to allow the linking member and the associated IPM attached to the linking member to translate vertically along the length of the channel. In an example, the translation channel(s) may be an elongated channel extending through the outer shell 302 of the child safety seat 300. FIGS. 3B and 3C provide additional views of the translation channel(s) 315.

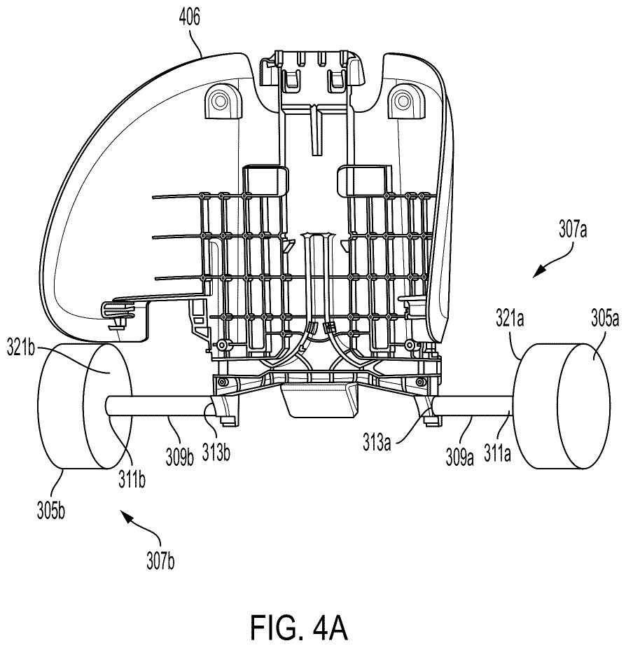

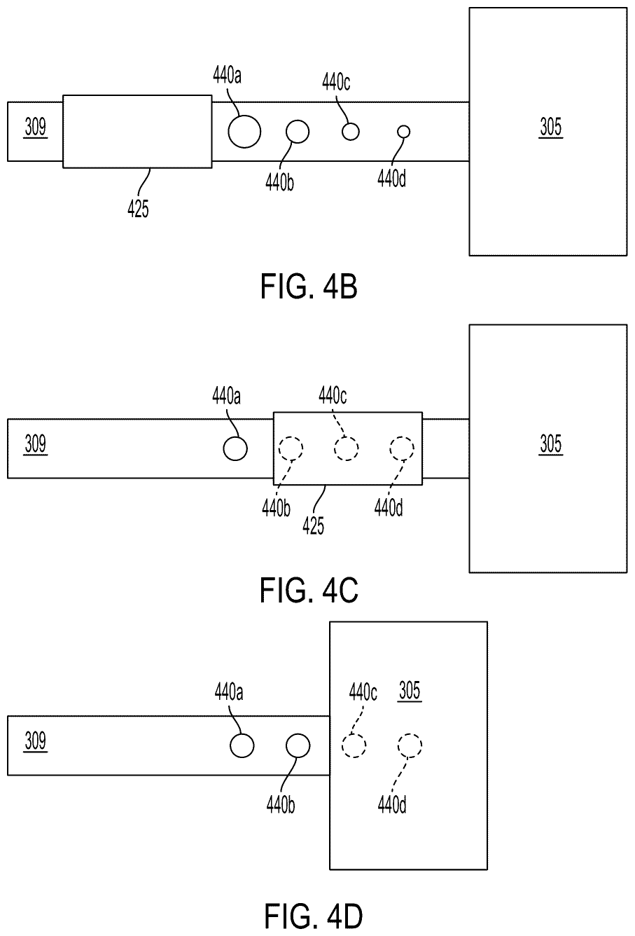

The translation channel(s) 315 may be sized and shaped to allow an IPM linking member (see linking members 309a, 309b of FIG. 4A) to extend through and move within the translation channel 315. For example, the channel width is sufficient to accommodate the diameter of the linking member such thereby allowing the linking member to travel and slide along the length of the channel (e.g., channel length (“CL”) 325. As the linking member 309 travels along the channel, the connected IPM translates vertically up and down along the length of the channel in unison with the linking member 309. It should be appreciated that while the translation channel(s) 315 provide clearance for the linking member(s) 309 to move within the channel, the fit between the channel and the linking member is tight enough such that the IPM is securely attached, without wobbling, and is both partially secured and guided by the translation channel(s) 315.

The translation channels 315a, 315b may be oriented in a translation plane (not pictured). In an example, the translation plane is parallel to a plane that the headrest 306 translates along such that as the headrest 306 is adjusted in the vertical direction, the IPM(s) are also adjusted in the same vertical direction. For example, the IPM(s) change their vertical orientation and translate along the translation channels 315 to match the height adjustment in the headrest 306. In this scenario, the channel length 325 may correspond to the travel distance of the headrest 306. For example, if the headrest 306 is vertically adjustable by 6.5-inch range of motion, the channel length 325 may be 6.5 inches.

### Impact Protection Module Linking Mechanisms

Turning now to FIG. 4A, which illustrates an example IPM 305a and IPM 305b (generally referred to herein as IPM(s) 305) coupled to an adjustable headrest 406. IPM(s) 305 may be connected or attached to a child safety seat through a linking member. In the illustrated example, IPM 305a is connected to adjustable headrest 306 via linking member 309a. The linking member 309a is coupled to the IPM 305a at interface 311a and to the adjustable headrest at interface 313a. Similarly, IPM 305b is connected to adjustable headrest 306 via linking member 309b at interfaces 311b and 313b.

In an example, the IPM(s) 305 and linking member(s) 309 may be a unitary component (e.g., a single injection molded or blow-molded component) or may be provided as an assembly. For example, the IPM 305a and linking member 309a may form IPM assembly 307a. Similarly, IPM 305b and linking member 309b may form IPM assembly 307b.

The IPM(s) 305 may be attached or coupled to the child safety seat, or more specifically the adjustable headrest 406, through various different means. In one example, the linking member 309 may be threaded on both ends such that the linking members may be threadingly coupled to the adjustable headrest (e.g., adjustable headrest has a corresponding threaded hole or collar adapted to accept the linking member). The IPM 305 may be coupled to the linking member through a similar threaded connection at interface 311. It should be appreciated that other types of connections between the IPM(s) 305, linking member(s) 309 and adjustable headrest 406 may be used, such as press-fit connections, other mechanical attachments including fasteners, adhesives, or the like.

IPM(s) may be attached to linking members 309 and similarly linking members 309 may be attached to the child safety seat, such as the headrest, through various attachment means. In an example, the attachment means may be similar to that illustrated in FIGS. 2 to 5B of U.S. Pat. No. 11,084,402 or those described in U.S. Pat. Nos. 7,726,734 and 7,717,506 to Applicant. Additional details regarding attachment and coupling of components is described in more detail below.

FIGS. 4B and 4C illustrate an example IPM 305 and linking member 309 with a plurality of vents 440a, 440b, 440c and 440d (hereinafter referred to generally as vent(s) 440). In the illustrated examples, the linking member may include vents 440, such as thru holes or apertures that allow air, gas or fluid within the IPM 305 and/or linking member 309 to escape during impact (e.g., while the IPM crumples). While vents 440 are depicted as circular, it should be appreciated that vents 440 can be any other shape and/or can be different shapes on a vent-by-vent basis. By adjusting the type, shape, or quantity of vents that are open, the dampening characteristics of the IPM may advantageously be tuned to accommodate passengers of different sizes and weights.

As illustrated in FIGS. 4B and 4C, the linking member 309 may include a moveable vent cover 425, which is configured to move along the linking member 309 to cover one or more of the plurality of vents 440. For example, the vent cover 425 may be positioned such that all of the vents 440a-c are unobstructed and open (FIG. 4B). In another example, the vent cover 425 may be adjusted to cover one or more vents, such as vents 440b-d (FIG. 4C). In other examples, the vent cover 425 may be adjusted to partially cover a vent, cover a single vent, cover multiple vents, or the like.

The vents 440 may be of different sizes (see FIG. 4B) or the same size (see FIG. 4C). Having vents with different sizes or different venting characteristics advantageously allows both linear and non-linear (e.g., progressive) changes to the venting profile of the IMP, thereby providing a wide range of venting profile adjustability for seat occupants of various ages, sizes, weights, and heights. Even though FIGS. 4B-4C illustrate four vents 440a-d, it should be appreciated that the linking member 309 may include more than four vents, less than four vents, or include alternate venting configurations, which are described in more detail later.

In the example illustrated in FIG. 4D, instead of a vent cover 425, the IPM 305 may be configured to block, close, or cover one or more vents 440 as the IPM 305 is adjusted laterally. For example, as the IPM 305 is threaded further onto linking member 309 to laterally adjust the IPM in towards the centerline of the child safety seat, one or more vents may be obstructed in the process, to ensure that the venting characteristics of the IPM are adjusted according to the IMP's lateral position. By obstructing vents as the IPM is moved laterally in towards the car seat, which reduces the distance between an outside surface of the IPM and the car seat, the venting is adjusted such that the IPM compresses or crumples more slowly as less air is able to escape. Additional information on venting is discussed in further detail below.

### Impact Protection Modules Design and Materials

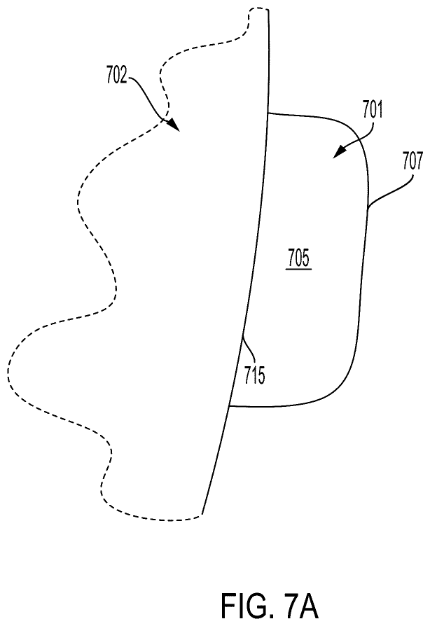

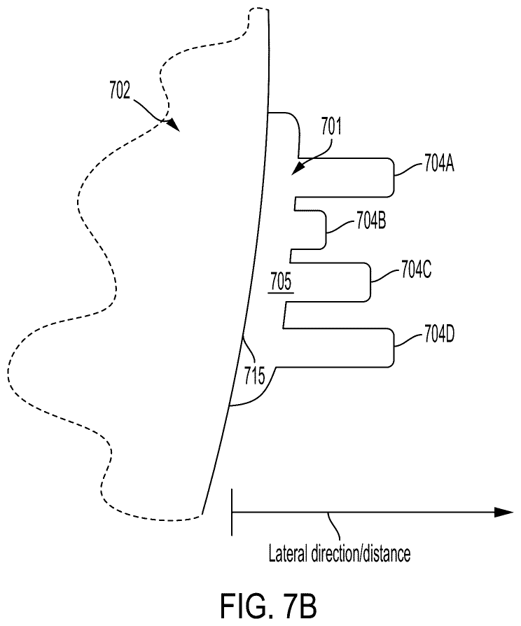

Looking ahead to FIGS. 7A and 7B, as illustrated in FIG. 7A, an IPM 705 comprises a body 701 of deformable material. The body 701 may be made a semi-rigid body, an inflatable body, or a hybrid body, which are described in more details below. Additionally, the IPM 705 has an outwardly facing surface 707 and an inwardly or occupant facing surface 715. The inward or occupant facing surface 715 may be configured to contact and spread impact forces across and through the outer shell 702 of the child safety seat. For example, occupant facing surfaces 715 with larger areas may advantageously pass and spread impact forces through and across a larger portion of the outer shell of a child safety seat, which advantageously reduces the amount of impact forces that are imparted on the occupant.

Semi-Rigid Examples: The IPMs 105, 205, 305, 705 may be formed of open cell foam, a suitable blow-moldable polymer, such as polypropylene (“PP”), ethylene vinyl acetate (EVA), low or high density polyethylene (“LDPE, HDPE”) or polystyrene (“PS”). The IPMs may further comprise liquid, gel or other energy absorbing material. For example, the IPMs may include an outer shell that is filled with liquid, gel, or other energy absorbing material. Additionally, liquid, gel or other energy absorbing material may be used in conjunction with an open cell foam, matrix, or cavity.

Referring back to FIGS. 4B, 4C and 4D, it should be appreciated that semi-rigid IPMs may include vents or the linking member(s) associated with the IPMs may include one or more vents 404 to allow air, gas, or fluid to escape as the IPM crumples. As discussed above, the vents 404 may be through holes in a blow-molded part, which advantageously allows air, gas, or fluid to vent during crumpling. In an example, the vents illustrated in FIGS. 4B, 4C and 4D may be an orifice, one-way valve, vented caps, or other related features. The inclusion of vents or other dampening adjustment mechanisms advantageously allow an IPM to be dynamically adapted to an occupant as the occupant grows, thereby ensuring that an occupant is provided side impact protection that is optimized and tuned to the occupant's height, weight, and/or size.

In an example, the IPMs may be hollow while having sufficient rigidity to maintain their nominal shape except when subjected to more than a predetermined minimum amount of impact. A hollow IPM may be configured to “crumple” upon exceeding the predetermined minimum amount of impact. As used herein, “crumple” or “crumpling” refers to the compression, deflation, deformation, caving in, rupturing, bursting, bending, or folding of the IPM. Additionally, as used herein, “optimal crumpling” refers to a scenario when the IPM is “crumpled” through most of or the maximum amount of allowable lateral compression distance (e.g., the IPM complete a full stroke of compression), while minimizing bottoming out effects. For example, “bottoming out” refers to an IPM experience pressures and forces that cause the IPM to crumple too rapidly, such that the IPM becomes fully crumpled or compressed before some or all of the impact forces from the crash are absorbed and distributed. Specifically, if the IPMs crumple, compress or deflate too rapidly, then bottoming out occurs and little or no protection is afforded. Conversely, if the IPMs crumple, compress or deflate too slowly, the IPM may act more like a rigid structure thereby minimizing their effect on reducing impact forces and increasing the risk that the child safety seat 100, 200, 300 will rebound off an adjacent passenger or a vehicle structure (e.g., inside of door). Thus, an IPM has the best impact performance (e.g., side-impact performance) when the IPM optimally crumples, specifically when the IPM crumples through the maximum amount of allowable lateral compression, performing a full-stroke without bottoming out.

The ability of an IPM to crumple advantageously allows the IPMs to minimize the effect of the force in an automobile collision in several ways. First, by crumpling, IPM advantageously transfers the kinetic energy of the car or child safety seat into controlled crumpling, at impact. The crumpling of the IPMs advantageously allows the child safety seat to extend the time before the seat abruptly jerks to a stop or impacts a portion of the vehicle, in effect lowering the average impact force, and decreasing the likelihood of a serious injury. Additionally, the child safety seat is less likely to rebound upon impact when associated with crumpling IPMs, which advantageously minimizes the momentum change and the impulse to the child occupant.

Furthermore, the IPMs may be sized, shaped, and positioned to minimize the energy felt on specific regions of a child, such as a child's head, neck, chest and vital organs, thereby reducing crash forces to a safer levels. Since the forces are lower (e.g., impact forces minimized) and dispensed over a longer period of time, the risk of serious injury is reduced.

Inflatable Examples: The IPMs may include one or more a vent(s), similar to the vents 440 illustrated in FIGS. 4B, 4C and 4D. The vents may be in the form of an orifice, one-way valve, vented caps, or vented skirts. The location of the vent(s) may be such that the vent(s) are not blocked when the IPM is installed on a child safety seat 100 (unless intended for adjusting venting or dampening characteristics), such that during an impact, the IPM may vent to deflate, thereby providing similar advantages to the “crumpling” described above. In an example, the one or more vents may include vent caps that are adapted to open at a predetermined pressure threshold and then deflate at a predetermined rate. In an example, the one or more vent(s) may include an orifice or opening on a portion of the IPM, such as an orifice or opening on the wall of a blow molded IPM. The orifice or opening may allow air to escape the hollow IPM as the IPM crumples during impact.

The quantity, size, and location of the one or more vent(s) affects the venting (e.g., rate at which air may be vented or exhausted from the IPMs) and thereby influences the ability of the IPMs to reduce the impact forces on the child safety seat 100, 200, 300 or the impact forces of the child safety seat 100, 200, 300 on an adjacent passenger. If the IPMs crumple or deflate too rapidly, then bottoming out occurs and little or no protection is afforded. Conversely, if the IPMs crumple or deflate too slowly, the IPM may act more like a rigid structure thereby minimizing their effect on reducing impact forces and increasing the risk that the child safety seat 100, 200, 300 will rebound off an adjacent passenger or a vehicle structure (e.g., intruding door). Thus, the IPMs may be provided with a sufficient number of vents that are adapted to allow air, gas, or fluid to escape at a suitable rate, thereby allowing the IPMs to crumple during a collision.

In other examples, the IPMs may be pre-filled or inflated with a liquid, gel or other energy absorbing material. Additionally, liquid, gel, or other energy absorbing material. These energy absorbing materials (e.g., gel) may also be allowed to escape through a vent, and the material properties of the energy absorbing materials (e.g., density, viscosity, or other similar properties) may be adapted to provide predictable “crumpling” behavior. For example, energy absorbing materials with higher densities and viscosities may vent slower than materials with lower viscosities.

In an example, the inflatable IPM may include multiple vents, where each vent or a subset of the vents has venting characteristics that are adapted for children of a specific weight range. For example, an IPM may have two different types of vents, such as a first style adapted to provide optimal crumpling for children under 30 lbs and a second style adapted to provide optimal crumpling for children above 30 lbs. In another example, the IPM may include more than two types of vents. Vents may be configured for various weight ranges (e.g., from a few pounds per range up to tens of pounds per range). For example, a first vent may be adapted to provide optimal crumpling a first weight range of up to 19 lbs).

Additionally, the IPM may include one or more vents with an adjustable vent dial. The vent dial may be a turn style dial, where turning the dial to the right decreases the venting rate. The vent dial may also include an indicator (e.g., arrow, notch) that is directed to a list of weights displayed around the vent dial. In an example, the vent(s) with adjustable vent dial(s) may have several different settings (e.g., selectable to specific set points, similar to teeth on a gear). In another example, the vent dial may provide a fully customizable amount of venting, similar to controlling flow with a ball valve, such that as a user turns the dial, the venting characteristics continuously change as the dial is turned. Specifically, instead of the specific set points of the previous example, this vent dial advantageously provides customizable venting for children at any weight range (e.g., adjusted every pound or every few pounds, although even tighter weight ranges could be used). By enabling continuous adjustment, the IPM's venting characteristics may be advantageously adjusted to achieve optimal crumpling at each stage of the child's growth, such that regardless of the child's weight, the IPM makes use of full stroke, while minimizing or eliminating bottoming out, thereby providing the best impact performance (e.g., side-impact performance) for every stage in a child's growth and development.

It should be appreciated that any of the vents or venting configurations described herein with respect to the IPMs may also be implemented on the coupling and/or linking members that link the IPMs to the headrest 106, 206, 306 (see FIGS. 4B, 4C and 4D as one example implementation). In another example, adjustment or translation of the headrest 106, 206, 306 may cause one or more vents to be activated, opened or released and/or one or more vents to be deactivated, closed or covered, such that the IPM has different venting characteristics depending on selected position (e.g., height) of the adjustable headrest 106, 206, 306. For example, the venting mechanism may be configured to restrict or dampen a rate of venting as the headrest 106, 206, 306 is adjusted to higher or taller positions to account for the occupants likely being heavier as they grow taller. By adjusting the venting characteristics of the IPMs in this way, the IPMs are advantageously adapted to provide tailored protection to occupants for various heights and weight ranges.

In another example, the size and shape of the vents may be implemented to provide non-linear venting or dampening adjustments. In alternative examples, the crumpling mechanics (e.g., compression rate) of an IPM may also be adjustable based on alignment. For example, an IPM may have multiple elements, pieces or regions arranged in a serial order. For example, the arrangement or serial order may define a compression rate (e.g., compression rate “A”), but as the headrest is adjusted vertically (e.g., moved up the serial order), the IPM some of the elements, pieces or regions of the IPM may become in parallel alignment resulting in a different compression rate (e.g., compression rate “B”).

In another example, adjustment of the venting characteristics of the IPM may be integrated with the lateral adjustment mechanism, some examples of which are described in more detail above with respect to FIGS. 4B, 4C and 4D. For example, the venting or damping characteristics of the IPM may be adjusted based on the amount the IPM is threaded into its corresponding coupler (see FIG. 4D). As described above, FIG. 4D illustrates an example where venting is reduced (e.g., more vents are obstructed) as the IPM is threaded further into the coupling member 309.

In another example, the vents may be arranged such that moving the IPM inward towards the child safety seat opens vents instead of closes them, which is counter to the example illustrated in FIG. 4D. Specifically, the IPM may be adjusted for more venting, such that the IPM crumples under less force, as the IPM is threaded further into the coupling. Conversely, the IPM may be adjusted for less venting as the IPM is unscrewed to increase the lateral position of the outside surface or effective lateral plane (e.g., a plane aligned with outwardly facing surface of the IMP) of the IPM(s).

Hybrid Examples: In an example, the IPMs may be formed of one or more layers an open cell foam, sponge-like matrix, or the like and covered with a membrane. The membrane may be a permeable membrane that allows air to escape upon impact, thereby allowing the IPM to compress or “crumple” during a vehicle collision. The membrane may be an air-tight or fluid-tight membrane with an opening and a sealing cap, allowing the IPMs to be deflated (air removed from open cell structure), thereby reducing the size and lateral position of the IPM. Further inflation or expansion of the IPMs may be used to further adjust or fine-tune the lateral position of the IPM. The sealing cap may be adapted to open at a predetermined pressure threshold, thereby allowing the opening to vent and the IPM to deflate. Other than being inflated with air or gas, it should be appreciated that the energy absorbing material(s) may be used in conjunction with an open cell foam, matrix, or cavity.

The ability to compress and/or deflate an IPM also advantageously assists with placing the IPM in storage. Providing ease of storage further increases the likelihood that IPMs will be available to occupants and further increases the likelihood of proper use (e.g., application and removal based on car seat occupancy, vehicle occupancy, and vehicle characteristics). The IPMs, when not in use, may be stored within storage compartments, slots, cavities, or the like on the child safety seat 100, 200, 300. Alternatively, to further reduce the weight, mass, and volume of the child safety seat 100, 200, 300 the IPMs may be stored in a separate storage compartment or container (e.g., storage bag) within the vehicle (e.g., under a seat, in a trunk, or other locations).

Other hybrid examples include an IPM with a plurality of sub-members (see FIG. 7B). For example, an IPM 705 may include a plurality of sub-members 704 (e.g., sub-members 704A-D, hereinafter referred to generally as sub-member(s) 704). The sub-member(s) may be (i) elastically deforming members, (ii) cushion members, (iii) deflating or bursting members, or the like. The plurality of sub-members 704 may be arranged such that their outer surfaces are located on the same lateral plane (e.g., same lateral distance from the seat). Alternatively, the plurality of sub-members 704 may be arranged such that their outer surfaces are located in different lateral planes or different lateral locations from the seat. By arranging sub-members 704 in different lateral positions (e.g., some sub-members being taller than others), as the IPM 705 is impacted, the sub-members are activated in succession and may provide a more gradual transition of forces. As illustrated in FIG. 7B, sub-member 704A and 704D have outer surfaces located in the same lateral plane and are “taller” than sub-members 704B and 704C. Additionally, by utilizing multiple sub-members 704 that crumple at different times and at different instances, the IPM 705 may advantageously be adapted for a wider range of impact forces and scenarios.

Similarly, an IPM 705 may include different types of sub-members 704, such that an IPM 705 may include a first sub-member (e.g., sub-member 704A and 704D) of open cell foam, a second sub-member (e.g., sub-member 704B) that is inflated with air and has a vent, and a third sub-member (e.g., sub-member 704C) that is a rupturing or bursting pocket of energy absorbing material (e.g., gel).

Similar to the serial order example discussed above, engagement of different sub-members 704 may define different compression rates or crumpling rates of the IMP(s). For example, as illustrated in FIG. 7B, sub-members may be the first sub-members to come into contact with an external object (e.g., intruding door) during a collision. Initially, sub-members 704A and 704D may start to compress at a first compression rate, then as the sub-members compress enough to reach the lateral position of sub-member 704C, sub-member 704C starts to compress along with sub-members 704A, D thereby changing the compression rate. If the collision is significant enough to compress the IPM to engage sub-member 704B, the sub-member 704B may compress with the remaining sub-members thereby again altering the compression rate of the IMP.

### Attachment Methods and Mechanisms

In an example, IPMs may be to the outer shell by means of a threaded attachment to a corresponding seated collar with corresponding mating threads. For example, threaded collars may be positioned within the outer shell and the IPMs may thread into the collar. For example, referring back to FIG. 2, the base portion 214 may have a threaded collar seated within or on the base portion that is configured to accept corresponding threads from the IPM or attachment feature associated with the IPM. Similarly, the outer shell 202 may have a threaded collar seated within or on the outer shell that is configured to accept corresponding threads from an IPM or IPM assembly. Additionally, the threaded attachment may have sufficient thread depth to advantageously allow the IPMs to be adjusted laterally on the child safety seat 100, 200, 300. For example, the lateral position of an IPM may be adjusted by further advancing the threads of the IPM into the corresponding collar. As noted above, lateral adjustments may be beneficial based on the arrangement of the child safety seat 100 in the vehicle, vehicle occupancy, and other vehicle characteristics (e.g., size, shape and location of arm rests, or other characteristics).

In an example, the threaded attachment and corresponding seated collar may include one or more elements/features and may be of similar construction as the threaded components and collars illustrated in FIGS. 2 to 5B of U.S. Pat. No. 11,084,402 to Applicant, the contents of which are incorporated by reference. In other examples, some IPMs may be attached to the child safety seat 100, 200, 300 by fixed attachment means such as adhesives or one-way bolts. Attachment may be by any suitable means, whether fixed or adjustable. Alternative attachment methods and mechanisms are described in U.S. Pat. No. 7,726,734 to Applicant and U.S. Pat. No. 7,717,506 to Applicant.

### Deployment, Adjustment and Removability

In the event of a crash, in particular from a side impact, there may be a tendency for the child safety seat 100, 200, 300 or a passenger in a seat adjacent to the child safety seat 100, to move as a result of the high impact forces. Also, in some instances with three child safety seats spanning a row of seating, IPM(s) on both sides of each child safety seat may be impractical due to space limitations. For example, there may be insufficient space for each child safety seat to deploy IPMs on both sides. In such an instance, the outside child safety seats may deploy IPMs on the side corresponding to the closest external door of the vehicle while the middle child safety seat deploys both IPMs. The deployability, adjustment, and removability of the IPMs advantageously allow the child safety seat to include enhanced protective features for various vehicle and passenger arrangements.

When the child safety seat 100, 200, 300 is provided with an IPM on a side between child safety seat 100, 200, 300 and an adjacent passenger, the risk of injury to both adjacent passenger and the occupant of the child safety seat 100, 200, 300 may advantageously be reduced in some collision scenarios. In the event of a crash, the impact of an adjacent passenger on the IPM(s), causes the IPM(s) to crumple, whether it be from a cavity within the IPM collapsing, open cell foam being compressed, air being vented or exhausted through a membrane, vent or orifice. The ability of the IPM to crumple on impact with the adjacent passenger or another object in the vehicle, the IPM advantageously decelerates the passenger and/or child safety seat 100, 200, 300 depending on the direction of impact and protects the passenger from the rigid outer shell of the child safety seat 100, 200, 300 and provides additional protection to the occupant of the child safety seat from any forces imposed by the passenger. Further, as the IPM crumples, there is less likelihood that the adjacent passenger or the child safety seat 100, 200, 300 will rebound after impacting each other.

### Vertical/Height Adjustments

In an example, the IPMs are configured to adjust positions to protect the child through the various stages of the child's growth. For example, as a child gets taller, the IPMs can be adjusted vertically (along the Y-direction in FIGS. 1B, 2, 5A, 5B) to ensure that the IPMs are oriented near the child's head, neck, shoulder, or vital organs.

FIGS. 5A and 5B depict IPM 305a at different vertical positions. As illustrated in FIG. 5A, the IPM 305a is at a vertical position 345a and at a height (HIPM) 347a in relation to the reference plane 350 from the bottom of the child safety seat. The vertical position 345a and height 347a correspond to the position (e.g., selected height) of the adjustable headrest 306, which is at a vertical position 335a and at a height (HHR) 337a in relation to the reference plane 350. Specifically, as the adjustable headrest is adjusted to a height 337a, the IPM 305a follows in unison and is adjusted to a vertical position 345a at a height 347a. The IPM 305a and adjustable headrest 306 are coupled together or linked and are able to vertically adjust in unison to ensure that as a child passenger grows, the protection afforded by the headrest 306 and IPM(s) 305 are oriented and positioned according to the child passenger's size. For example, as shown in FIG. 5A, the IPM(s) 305 may cover a protection zone or range equivalent to the channel length 325.

FIG. 5B depicts IPM 305a at a lower vertical position, which may be more suitable for a smaller child. As shown in FIG. 5B, the IPM 305a is at a vertical position 345b at a height 347b, which corresponds to the vertical position 335b and height 337b of the adjustable headrest. Depending on the adjustability of the headrest 306, the IPM(s) 305 may be vertically adjustable in a stepwise fashion at distinct and selectable adjustment heights. For example, the headrest may be adjustable to four different selectable heights and thus the IPM(s) 305 may have four different corresponding positions along the translation channel corresponding to the four different selectable heights of the headrest 306. Alternatively, the adjustable headrest 306 (and thus the linked IPM(s) 305) may be continuously adjustable between a range of heights such that the headrest and IPM(s) may be moved to any position within the range.

By linking the IPMs 305 to a translating headrest 306, the IPMs 305 are advantageously positioned to appropriate areas on the child as the child grows (e.g., IPMs 305 translate and adjust along with headrest 306 height adjustments). For example, as the headrest 106, 206, 306 is adjusted to a higher vertical position, the IPM is similarly adjusted to a higher vertical position, which ensures that the IPM maintains alignment with protection regions of interest on the occupant child. For example, the protection regions of interest may be the child's head, neck, and chest.

Referring back to FIG. 4, even though the IPM(s) 305 may be attached to the headrest, each IPM 305 has an engagement surface that is configured to engage the outer shell of the child safety seat in the event of an impact. For example, IPM 305a has an engagement surface 321a that is configured to engage the outer shell of the child safety seat, which advantageously imparts forces over a broad area of the safety seat throughout the outer shell instead of the forces being solely concentrated in the headrest. Similarly, IPM 305b has an engagement surface 321b that is configured to engage the outer shell of the child safety seat. It should be appreciated that the engagement surfaces described with respect to FIGS. 4A and 4B may function in a similar fashion as the inward or occupant facing surface(s) described in FIGS. 7A and 7B.

Specifically, the IPM(s) 305 may have a small gap or clearance between the outer shell of the child safety seat and their corresponding engagement surfaces. During an impact and collision, forces imparted on the IPM(s) 305 may translate through the linking members, causing the IPM(s) and/or linking members to compress or crumple enough such that the engagement surface 321 of the IPM 305 is in direct contact with the outer shell of the child safety seat and forces imparted on the IPM are translated to and through the outer shell.

It should be appreciated that the linking between the headrest and the IPM(s) is strong and rigid enough such that both components translate together along the Y-axis or in the Y-direction, but deformable enough such that the linking mechanism crumples before imparting significant forces on the headrest. Instead, the forces and energy are at least partially absorbed by the IPM(s) and distributed throughout and across the outer shell and other structural/skeletal components of the child safety seat. Specifically, even though the linking mechanism ties translation of the headrest with the IPM(s), the linking mechanism is configured in such a way that the majority of impact forces are maintained on and spread throughout/across the outer shell and other impact absorbing structures of the child safety seat, thereby diverting potentially dangerous forces away from the occupant and the occupant's head/neck region.

### Lateral/Depth Adjustments

As discussed above, the position of the IPM(s) 305 may be adjusted vertically. FIGS. 6A and 6B illustrate IPM(s) 305 adjusted to different lateral positions. Specifically, FIGS. 6A and 6B illustrate an example block schematic of IPM(s) 305 at different lateral positions. For example, in FIG. 6A, the child safety seat has two IPMs 305a, 305b attached to the child safety seat with one IPM on each side. In the illustrated example, IPM 305a has an outwardly facing surface 607 that is at a first lateral position 611a that is spaced apart from the centerline 650 of the child safety seat by a lateral distance (DL) 621a. Similarly, the IPM 350b on the opposite side of the child safety seat is spaced apart from the centerline 650 by the same lateral distance. However, each IPM 305 may be adjusted to different lateral positions, such that a child safety seat may have multiple IPMs that are adjusted to different lateral positions.

As illustrated in FIG. 6B, IPM 305b has been completely removed from the child safety seat. Additionally, IPM 305a is adjusted such that the outwardly facing surface 607 is moved to a second lateral position 611b that is spaced apart from centerline 650 by a lateral distance (DL) 621b. In the example, the lateral distance 621b is greater than the lateral distance 621a. In an example, the lateral position of the IMP(s) 305 may be adjusted to account for or compensate for interior vehicle characteristics or vehicle occupancy. For example, some vehicles have protruding armrests on doors that may affect what parts of the child safety seat are impacted during an accident. In one example, an IPM 305 may be laterally adjusted such that the IPM 305 is the most likely first point of contact during an impact or accident.

In other examples, the lateral position of an IPM may be adjusted based on a passenger's size. For example, and IPM 305 that is adjusted to have a greater lateral distance from the centerline may provide a longer crumpling stroke and thus a longer crumpling duration. In some examples, the damping characteristics of an IPM may be based on the lateral position of the IPM. For example, IPMs positioned further from the child safety seat may have a longer compression stroke and therefore may be afforded the opportunity to absorb more impact forces before bottoming out, which advantageously absorbs and safely spreads a majority of the initial impact forces before imparting the remaining forces to the child safety seat. For example, once the IPM is fully compressed, its ability to absorb additional forces is effectively nullified and the remaining forces may act on the child safety seat as if the IPM was not deployed.

In an example, the lateral or depth adjustment mechanism may be similar to that of FIGS. 3 to 7 of U.S. Pat. No. 9,908,444 to Applicant. Furthermore, as discussed above, the lateral or depth adjustment mechanism may be similar to that of FIGS. 2 to 5B of U.S. Pat. No. 11,084,402 to Applicant.

### Venting/Dampening Adjustments

Various venting and dampening adjustment examples are described above with respect to FIGS. 4B, 4C and 4D and in the “IMPACT PROTECTION MODULES DESIGN AND MATERIALS” section above. As detailed above, open vents may increase the compressibility of the IPM, such that the IPM compresses more easily. In an example, the vents may be positioned in a way that the orifices are not located on the identical planes, but instead may be oriented on various planes causing a step-by-step closure of the vents. For example, the stepwise closure of the vents through the IPM contacting the intruding door may provide dynamic dampening characteristics and compression of the IPM.

By implementing the closure of vents in a stepwise fashion, the IPM may dynamically become less compressible as the IPM approaches its full compression stroke, which advantageously allows as much of a full compression stroke as possible for different impact forces. Specifically, with all vents initially open, the IPM is easily compressible and will compress rather easily initially upon impact. If the impact forces are sufficient to compress the IPM enough to being closing vents, the IPM becomes less compressible and less likely to bottom-out. With that, damping characteristics may be progressively adapted to have a lower damping rate at higher compression of the IPM.

In other examples, the vents may be arranged such that the occupant, when positioned within the child safety seat, closes vents or orifices of the IPM. For example, the occupant may be positioned within the child safety seat to close a vent or orifice with his/her shoulder. The vents may be arranged such that different statures and sizes of occupants will cover bigger or smaller surfaces or vent holes at different locations on the inner side of the child safety seat.

It should be appreciated that reference to or description of certain features herein from one Figure may apply and correspond to similar features from another Figure. For example, descriptions and features of child safety seat 100 may also similarly apply to child safety seats 200, 300. Similarly, descriptions and features of IPM 105 may also similarly apply to IPMs 205, 305, 705, or the like. The same holds true for the various structural features of the child safety seats (e.g., headrest 106, 206, 306).

Although the present invention has been described in certain specific aspects, many additional modifications and variations would be apparent to those skilled in the art. In particular, any of the various processes described above can be performed in alternative sequences and/or in parallel in order to achieve similar results in a manner that is more appropriate to the requirements of a specific application. It is therefore to be understood that the present invention can be practiced otherwise than specifically described without departing from the scope and spirit of the present invention. Thus, embodiments of the present invention should be considered in all respects as illustrative and not restrictive. It will be evident to the annotator skilled in the art to freely combine several or all of the embodiments discussed here as deemed suitable for a specific application of the invention. Throughout this disclosure, terms like “advantageous”, “exemplary” or “preferred” indicate elements or dimensions which are particularly suitable (but not essential) to the invention or an embodiment thereof, and may be modified wherever deemed suitable by the skilled annotator, except where expressly required. Accordingly, the scope of the invention should be determined not by the embodiments illustrated, but by the appended claims and their equivalents.

### Adjustable Self-Deploying Inner Arm Rests

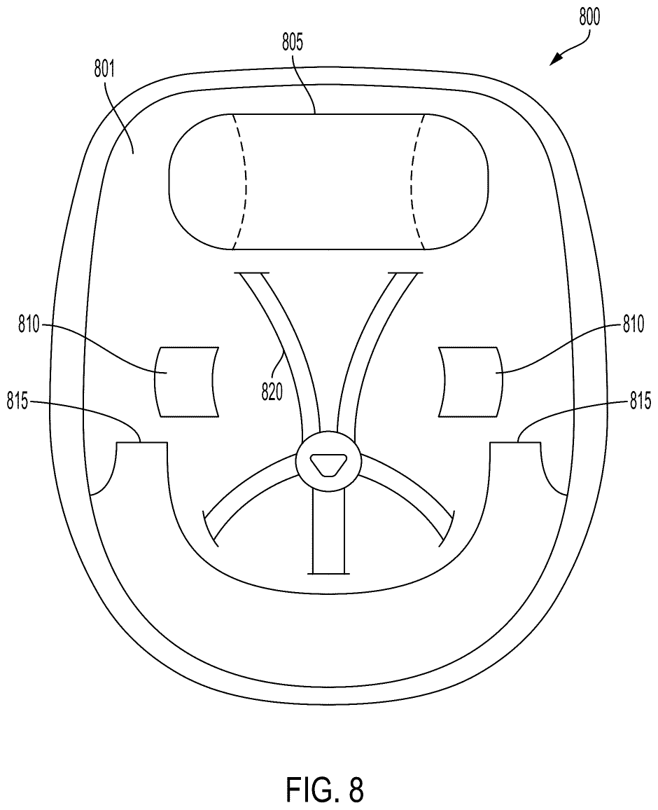

FIG. 8 shows a front view of a child safety seat with adjustable self-deploying inner arm rests. As seen in FIG. 8, the child seat 800 includes an inner portion 801 in into which the occupant is placed. The child seat includes an adjustable headrest 805, a pair of outer arm rests 815, a harness 820, and a pair of adjustable self-deploying inner arm rests 810. The inner arm rests 810 are located such that the distance between the inner arm rests 810 and the harness 820 is smaller than the distance between the outer arm rests 815 and the harness 820. In use, this means that when an occupant is placed on the child seat 800, the inner arm rests 810 are closer to the occupant, than the outer arm rests 815. In turn the inner arm rests 810 provide arm support for smaller occupants, such as infants.

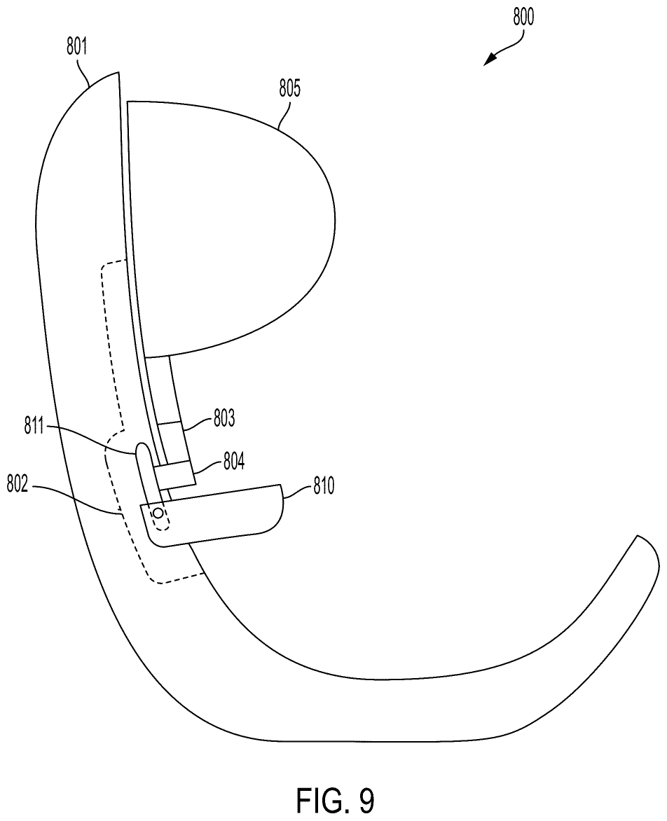

FIG. 9 shows a side view of a child safety seat with adjustable self-deploying inner arm rests in a deployed configuration. As seen in FIG. 9, the adjustable headrest 805 couples the inner arm rest 810 via multiple connectors 803, 804. In this embodiment one connector 804 engages an inner arm actuator 811. In the deployed configuration, when the user moves the adjustable headrest 805 down vertically, the connectors 803, 804 move concurrently, and in turn engage the inner arm actuator 811. Once the arm actuator is engaged, the inner arm rest 810 moves out of an inner arm cavity 802. In turn, once the user moves the adjustable headrest 805 down, the inner arm rest 810 is deployed from its inner arm cavity 802. As such, when the headrest 805 is down vertically, the inner arm rests 810 automatically deploy, such that in this overall configuration a smaller, infant occupant is comfortable.

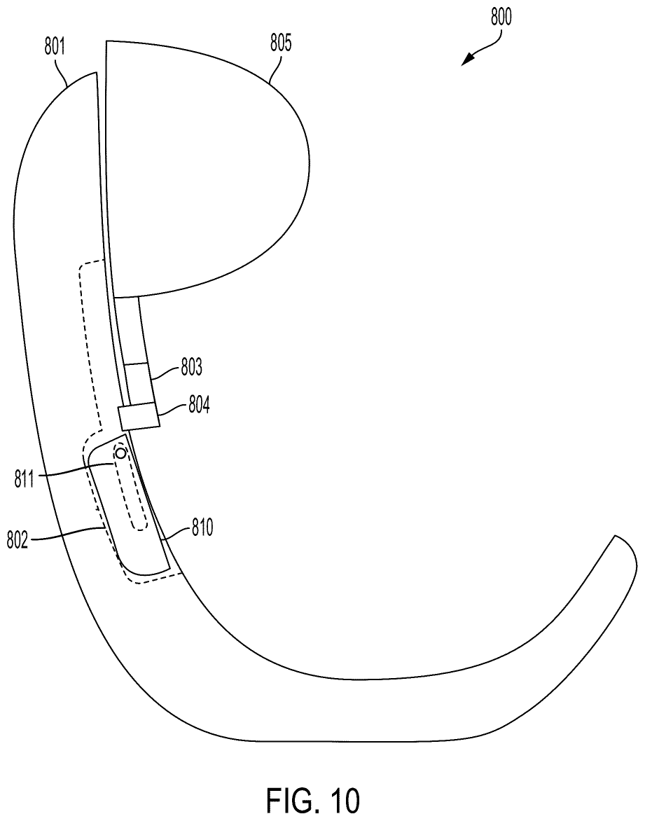

FIG. 10 is a side view of a child safety seat with adjustable self-deploying inner arm rests in a stored configuration. As seen in FIG. 10, in the stored configuration, when the user moves the adjustable headrest 805 up vertically, the connectors 803, 804 move concurrently, and in turn disengage the inner arm actuator 811. Once the arm actuator is disengaged, the inner arm rest 810 moves into the inner arm cavity 802. In turn, once the user moves the adjustable headrest 805 up, the inner arm rest 810 pivots up and into the inner arm cavity 802, such that it is in a stored configuration, flush with the rest of the child seat. As such, when the headrest 805 is up vertically, the inner arm rests 810 automatically stores, such that in this overall configuration, a larger occupant is comfortable, without inner arm rests 810 taking up occupant space.

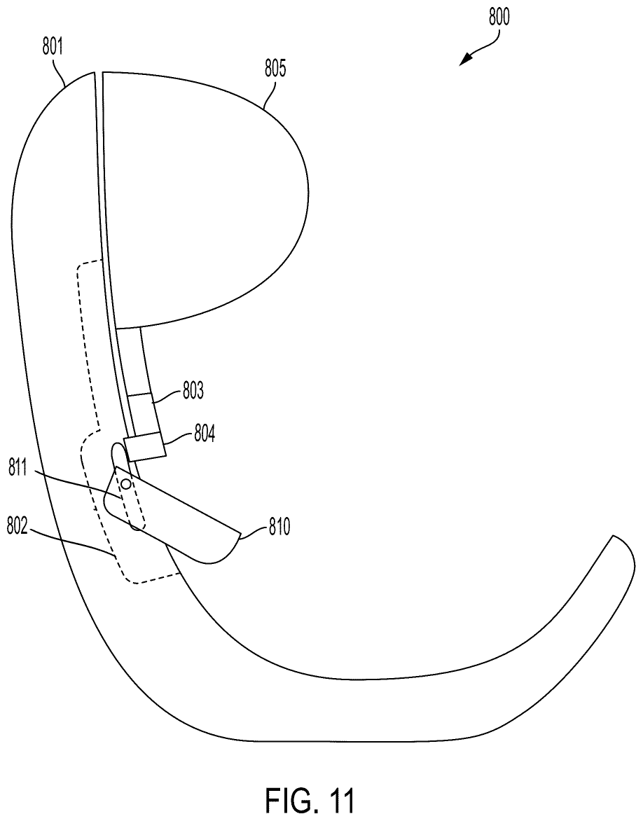

FIG. 11 is a side view of a child safety seat with adjustable self-deploying inner arm rests between a deployed and stored configuration. As seen in FIG. 11, between the stored configuration (seen in FIG. 10) and deployed configuration (seen in FIG. 9), as the user moves the adjustable headrest 805 up vertically, the connectors 803, 804 move concurrently, and in turn disengage the inner arm actuator 811. Once the arm actuator is disengaged, the inner arm rest 810 moves into the inner arm cavity 802. In turn, once the user moves the adjustable headrest 805 up, the inner arm rest 810 pivots up and into the inner arm cavity 802.

1. A child safety seat comprising:
an outer shell;
an adjustable headrest, the headrest moveable with respect to the outer shell between a first position and a second position; and
at least one impact protection module (“IPM”), wherein the IPM is coupled to the adjustable headrest such that the IPM moves in coordination with the adjustable headrest.

2. The child safety seat of claim 1, wherein the at least one IPM is sized and shaped to cover a protection area of interest on a child occupying the child safety seat.

3. The child safety seat of claim 1, wherein the at least one IPM is laterally adjustable to a plurality of different lateral positions and wherein the at least one IPM is vertically adjustable to a plurality of different vertical positions.

4. The child safety seat of claim 1, wherein the IPM has compression characteristics based on a lateral position of the first IPM.

5. The child safety seat of claim 1, further comprising a linking member attached to the IPM and the adjustable headrest.

6. The child safety seat of claim 5, further comprising a moveable vent cover, wherein the linking member includes a plurality of vents and the moveable vent cover is configured to selectively change a state of at least one of the plurality of vents.

7. The child safety seat of claim 6, wherein the state of at least one of the plurality of vents includes an open state, a closed state, and a partially open state.

8. The child safety seat of claim 5, wherein at least one of the IPM and the linking member include at least one vent.

9. The child safety seat of claim 8, wherein the at least one vent includes a plurality of closable vents configured to change compression characteristics of the IPM based on which of the plurality of vents is open or closed.

10. The child safety seat of claim 1, wherein the at least one IPM includes a first IPM arranged on an upper portion of a first side of the child safety seat.

11. The child safety seat of claim 10, further comprising a second IPM arranged on a lower portion of the first side of the child safety seat, wherein the second IPM is threadingly attached to the child safety seat, and wherein further thread engagement between the IPM and the child safety seat causes the IPM to laterally move towards a centerline of the child safety seat.

12. The child safety seat of claim 11, wherein the at least one adjustable IPM includes a first IPM on a left-hand-side of the child safety seat and a second IPM is arranged on a right-hand-side of the child safety seat.

13. An impact protection module (“IPM”) adapted for a child safety seat, comprising:
a compressible body portion having an inward facing surface and an outward facing surface, the inward facing surface configured to contact an outer shell of the child safety seat upon impact, thereby transferring impact forces to the outer shell of the child safety seat; and
a coupling interface configured for removably and adjustably coupling the IPM to the child safety seat.

14. The IPM of claim 13, wherein the coupling interface is configured to couple the IPM to an adjustable headrest of the child safety seat such that movement of the adjustable headrest and the IPM are linked with each other.

15. The IPM of claim 13, wherein the IPM is one of (i) a hollow rigid body, (ii) an inflatable body, (iii) a semi-rigid body, (iv) a burstable body, or a combination thereof.

16. The IPM of claim 13, wherein the compressible body portion includes a plurality of sub-members, and wherein the plurality of sub-members includes a first sub-member, a second sub-member, and a third sub-member, and wherein at least one of the sub-members includes a vent.

17. The IPM of claim 16, wherein at least one sub-member of the plurality of sub-members has a different compression characteristic than at least one other sub-member of the plurality of sub-members.

18. A child safety seat comprising:
an inner shell, with a back area and a seat area;
inner arm rests, the inner arm rests moveable with respect to the back of the inner shell between a first position and a second position; and
an adjustable headrest, the adjustable headrest moveable in a top vertical position and a bottom vertical position with respect to a seating area of the child safety seat.

19. The child safety seat of claim 18, wherein the inner shell includes inner arm cavities corresponding in size with the inner arm rests, and wherein the inner arm rests move between the first position and the second position such that the arm rests are in the first position when the adjustable headrest is in the top vertical position, and wherein the arm rests are in the second position when the adjustable headrest is in the bottom vertical position.

20. The child safety seat of claim 19, wherein in the first position the inner arm rests are stored in the inner arm cavities, and wherein in the second position the inner arm rests are in a position parallel with the seat area of the inner shell.
